(19) United States
(12) Patent Application Publication
(10) Pub. No.: US 2005/0110878 A1
(43) Pub. Date: May 26, 2005

(54) Managing images captured by a digital camera

(76) Inventor: Dan L. Dalton, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/717,891

(22) Filed: Nov. 20, 2003

(51) Int. Cl. H04N 5/76; H04N 5/222

(52) U.S. Cl. 348/231.2; 348/333.01

(57) ABSTRACT

Disclosed are a digital camera and methods for managing images captured by the digital camera. A method implemented by a digital camera, comprising the steps of receiving a first user input corresponding to an image displayed by a digital camera; converting a first set of data corresponding to the image to a second set of data responsive to the first user input, wherein the second set of data is smaller than the first set of data; and storing the second set of data in non-volatile memory.

### BACKGROUND

Digital cameras enable users to capture and store digital images. One-problem associated with digital cameras is that they have a limited amount of internal memory and/or a limited amount of memory on a removable memory card. Therefore, users periodically transfer images from the camera memory to a computer or other device, and then delete the pictures from the camera memory, thus making room for new pictures to be taken. When exceptionally good pictures are taken, the user may want to keep them in the camera memory where they can be reviewed and shared with others. However, retaining old images in the digital camera's memory can greatly reduce the amount of memory available for taking new pictures.

Another problem associated with digital cameras is that a user may lose images captured by a digital camera that were valuable to the user. For example, images may be intentionally or unintentionally deleted from a digital camera or a memory card coupled to the digital camera. Images may be intentionally deleted to free-up memory for additional images, or may be unintentionally deleted when they are downloaded to a personal computer. Furthermore, a user may lose valuable images when a memory card that stores such images is lost or damaged.

Yet another problem with digital cameras is that many of the pictures taken by the digital camera may be undesirable, and deleting all the undesirable pictures individually may be too time consuming. A further problem with digital cameras is that they do not enable users to effectively filter images displayed or output by the digital camera.

### SUMMARY

Disclosed are a digital camera and methods for managing images captured by the digital camera. An embodiment of a method implemented by a digital camera includes the steps of receiving a first user input corresponding to an image displayed by a digital camera, down-sampling image data corresponding to the image responsive to the first user input, and storing the down-sampled image data in non-volatile memory.

Another embodiment of a method implemented by a digital camera includes the steps of receiving a first user input corresponding to an image displayed by a digital camera, and responsive to receiving the first user input, retrieving image data corresponding to the image from a removable memory card coupled to the digital camera, and storing image data corresponding to the image in non-volatile memory that is part of the digital camera.

A further embodiment of a method implemented by a digital camera includes the steps of receiving a plurality of user inputs corresponding to a plurality of respective images displayed by the digital camera, designating the plurality of images as favorite images responsive to the plurality of respective user inputs, receiving another user input corresponding to an option to display favorite images, and displaying at least one of the plurality of images responsive to receiving the other user input.

An embodiment of a digital camera includes non-volatile memory and at least one processor that is programmed to down-sample image data corresponding to an image displayed by the digital camera responsive to the digital camera receiving a user input, and to provide the down-sampled image data to the non-volatile memory.

Another embodiment of a digital camera includes a display and at least one processor that is programmed to designate a plurality of images as favorite images responsive to the digital camera receiving a plurality of respective user inputs, and to provide image data corresponding to at least one of the plurality of images to the display responsive to the digital camera receiving another user input corresponding to an option to display favorite images.

A further embodiment of a digital camera includes means for receiving a plurality of user inputs corresponding to a plurality of respective images displayed by the digital camera, means for designating the plurality of images as favorite images responsive to the plurality of respective user inputs, and means for displaying at least one of the plurality of images responsive to receiving another other user input corresponding to an option to display favorite images.

Other systems, methods, and features will be or become apparent upon examination of the following drawings and detailed description. It is intended that all such additional systems, methods, and features be included within this description.

### BRIEF DESCRIPTION OF THE DRAWINGS

A digital camera and methods for managing images captured by the digital camera are illustrated by way of example and not limited by the implementations illustrated in the following drawings. The components in the drawings are not necessarily to scale. Like reference numerals designate corresponding parts throughout the several views.

FIG. 1 is a block diagram depicting an example of components of a digital camera.

FIG. 2 is a schematic diagram depicting a rear view of the digital camera represented in FIG. 1.

FIG. 3 is a schematic diagram depicting an example of a favorites menu displayed by the display screen depicted in FIG. 2.

FIG. 4 is a schematic diagram depicting an example of a folder-selection menu displayed by the display screen depicted in FIG. 2.

FIG. 5 is a schematic diagram depicting an example of a delete-from-favorites menu displayed by the display screen depicted in FIG. 2.

FIG. 6 is a flow chart depicting an example of a method for managing images captured by the digital camera depicted in FIG. 1.

FIG. 7 is a flow chart depicting an example of a method for displaying favorite images by the digital camera depicted in FIG. 1.

FIG. 8 is a flow chart depicting an example of a method for managing images captured by the digital camera depicted in FIG. 1.

FIG. 9 is a flow chart depicting another example of a method for managing images captured by the digital camera depicted in FIG. 1.

FIG. 10 is a flow chart depicting another example of a method for managing images captured by the digital camera depicted in FIG. 1.

FIG. 11 is a block diagram depicting an example of a favorite images viewing system that includes the digital camera depicted in FIG. 1.

### DETAILED DESCRIPTION

Disclosed are a digital camera and methods for managing images captured by the digital camera. According to one such method, a digital camera enables a user to designate a captured image as a favorite image. The user may designate an image as a favorite image by selecting an option displayed on the digital camera's display screen (e.g., via a user-input panel). Images that are designated as favorite images are down-sampled and then stored in the digital camera's internal memory. An image is said to be down-sampled when it's resolution and the amount of data used to encode it are reduced. In this manner, many user-designated favorite images may be accessible by a user at a future time. For example, the favorite images may even be accessible after the corresponding image data has been downloaded to a personal computer (PC), and/or if the memory cards previously used to store the corresponding image data are not available or have had their contents erased or over-written.

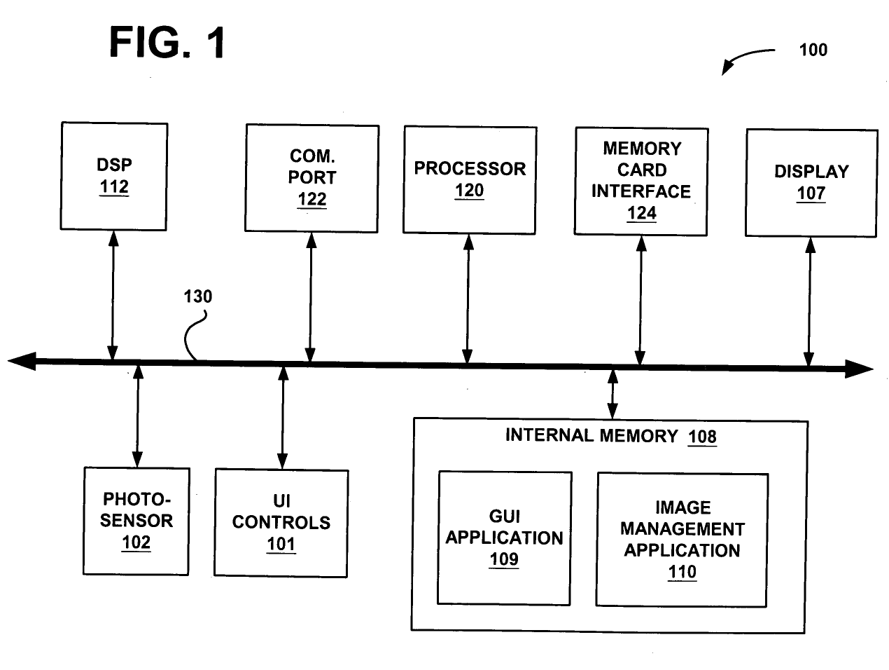

FIG. 1 is a block diagram depicting an example of components of a digital camera 100. The digital camera 100 includes a photo-sensor 102 for capturing images, a digital signal processor (DSP) 112 for manipulating images, a display screen 107 for displaying images, memory 108 for storing firmware and/or captured images, a processor 120 for executing firmware stored in the memory 108, user-input (UI) controls 101 for receiving user input, and one or more communication ports 122 for transferring image data to or from another device. The UI controls 101 may include physical controls such as, for example, buttons, rocker switches, and/or a key pad for receiving user input. Alternatively, the display screen 107 may be touch-sensitive, and may thus display virtual controls for receiving user input.

The memory 108, which may include a combination of volatile and non-volatile memory, stores a graphical user interface (GUI) application 109 and an image management application 110. These applications 109 and 110 may be executed by the processor 120, which may be a general purpose or a custom-made processor configured to execute program code.

The GUI application 109 is configured to provide a user with selectable options via the display screen 107. Options provided by the GUI application 109 include options related to designating images captured by the digital camera 100 as favorite images, as will be described in more detail below. The image management application 110 is configured to down-sample and/or compress images designated by a user as favorite images. In an alternative embodiment, the down-sampling and/or compression of favorite images may be performed at least in part by hardware (e.g., an application specific integrated circuit (ASIC)).

The digital camera 100 may be coupled to a removable memory card (not shown) via a memory card interface 124. The memory card and/or the internal memory 108 may be used to store images captured by the digital camera 100. According to one embodiment, images that are stored in a memory card and then designated as favorite images by a user are transferred from the memory card to the internal memory 108.

A communication port 122 may, for example, enable favorite images to be transferred form the digital camera 100 to a personal computer (PC) or other device for storage (e.g., backup) or for subsequent viewing via a computer monitor coupled to the PC. Favorite images may also be transferred to the digital camera 100 from a PC or other device, thus allowing users to sort, group, edit, annotate, or otherwise modify favorite images that may then be displayed by the digital camera 100 or by a television that is coupled to the digital camera 100.

Each communication port 122 may comprise, for example, a serial port, a parallel port, a small computer system interface (SCSI), an infra-red (IR) interface, a wireless radio frequency (RF) interface, or a universal serial bus (USB) interface. In a preferred embodiment, digital camera 100 includes a communication port 122 configured to be coupled to a television.

The above-mentioned components of the digital camera 100 may be communicatively coupled via a local interface 130, which may comprise, for example, one or more buses or other wired or wireless connections. The local interface 130 may include additional elements, which are omitted for simplicity, such as, for example, controllers, buffers, drivers, repeaters, and/or receivers, to enable data transfer and communications between components of the digital camera 100.

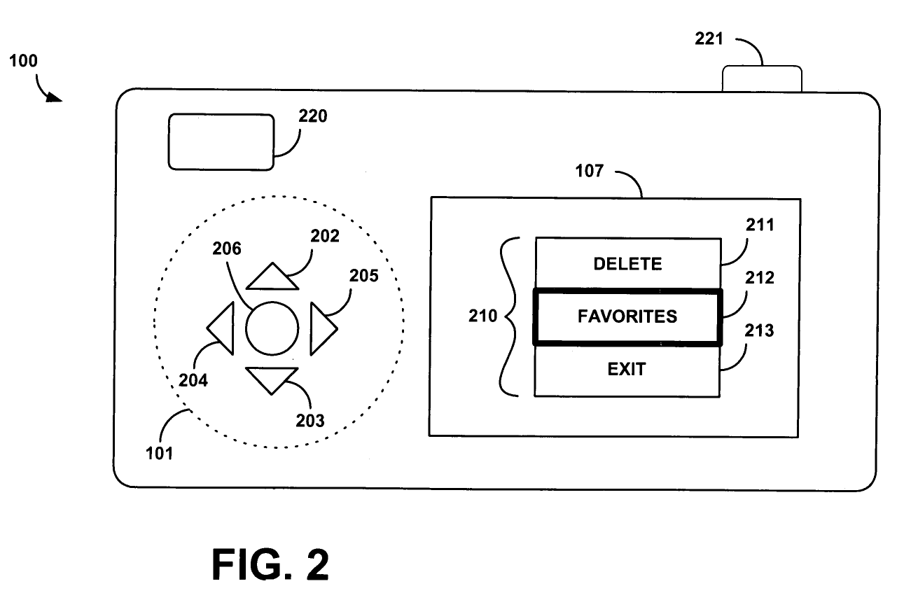

FIG. 2 is a schematic diagram depicting a rear view of the digital camera 100. The digital camera 100 may include user-input keys 101, a view-finder 220, an image-capture key 221, and a display screen 107. The image-capture key 221 may be activated to cause the digital camera 100 to capture an image that is visible via the view-finder 220.

The display screen 107 displays images captured by the digital camera 100 as well as menu options for manipulating the images. The user-input keys 101 may include an up-arrow key 202, a down-arrow key 203, a left-arrow key 204, a right-arrow key 205, and an option-selection key 206. In one embodiment, the up-arrow key 202 and the down-arrow key 203 are used to scroll through menu options displayed by the display screen 107, the option-selection key 206 is used to select a highlighted menu option, and the left-arrow key 204 and the right-arrow key 205 are used to scroll through images displayed by the display screen 107. When an image captured by the digital camera 100 is displayed by the display screen 107, a main menu comprising options related to the displayed image may be requested by activating the option-selection key 206.

In one embodiment, among others, the main menu 210 includes a delete option 211, a favorites option 212, and an exit option 213. A user may select an option from the main menu 210 by using, for example, the user-input keys 101. A user may cause the main menu 210 to be displayed by, for example, pressing the option-selection key 206 while an image is being displayed by the display screen 107. Such an image may continue to be displayed in the background of the main menu 210. A user may select the delete option 211 in order to cause the image to be deleted from memory, or the exit option 213 to “exit” from the menu. The favorites option 212 may be used to access another menu containing options related to a user's favorite images.

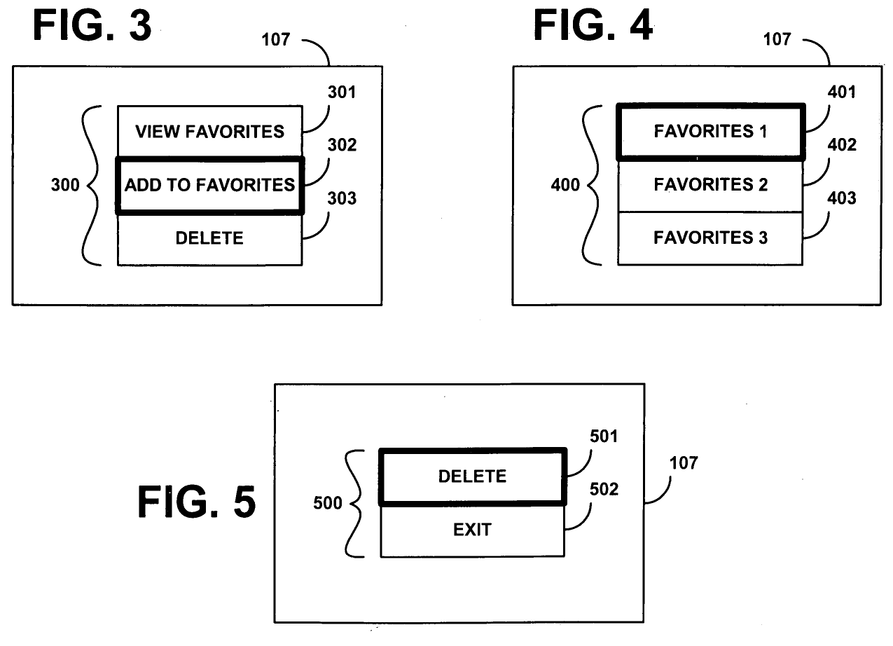

FIG. 3 is a schematic diagram depicting an example of a favorites menu 300. The favorites menu 300 includes a view-favorites option 301, an add-to-favorites option 302, and a delete-from-favorites option 303. A user may select an option from the favorites menu 300 by using, for example, the user-input keys 101. A user may cause the favorites menu 300 to be displayed by, for example, pressing the option-selection key 206 while the favorites option 212 is highlighted in the main menu 210 (FIG. 2). The user may select the view-favorites option 301 to cause previously designated favorite images to be displayed.

A user may select the add-to-favorites option 302 to designate an image as a favorite image. The image that is designated as a favorite image may be the currently displayed image on the display screen 107. If no image is currently displayed, then the image that is designated as a favorite image would be the image that was being displayed immediately prior to the display of the main menu 210 (FIG. 2).

FIG. 4 is a schematic diagram depicting an example of a folder-selection menu 400. In the example shown in FIG. 4, the folder-selection menu 400 includes a first favorites folder 401, a second favorites folder 402, and a third favorites folder 403. A user may select an option from the folder-selection menu 400 by using, for example, the user-input keys 101. A user may cause the folder-selection menu 400 to be displayed by, for example, pressing the option-selection key 206 while the add-to-favorites option 302 is highlighted in the favorites menu 300 (FIG. 3). The folder-selection menu 400 may be used to designate a favorite folder for a selected image. In this manner, a user may store images having a common theme in the same folder, if desired.

The folder-selection menu 400 may also be displayed in response to a user selecting the view-favorites option 301 form the favorites menu 300 (FIG. 3). According to such an implementation, the folder-selection menu 400 may be used to cause images corresponding to a certain folder to be displayed by the display screen 107. For example, by selecting the first favorites folder 401, one or more images associated with a first favorites folder are displayed. A user may then use the user-input keys 101 to scroll through the displayed images.

FIG. 5 is a schematic diagram depicting an example of the delete-from-favorites menu 500. the delete-from-favorites menu 500 includes a delete option 501 and an exit option 502. A user may select an option from the delete-from-favorites menu 500 by using, for example, the user-input keys 101. A user may cause the delete-from-favorites menu 500 to be displayed by, for example, pressing the option-selection key 206 while a favorite image is being displayed. A user may select the delete option 501 to “delete” a selected image from a corresponding favorites folder. As a result of selecting the delete option 501, the deleted image would no longer be displayed by the display screen 107 the next time a user accesses the favorites folder in which the selected image was stored.

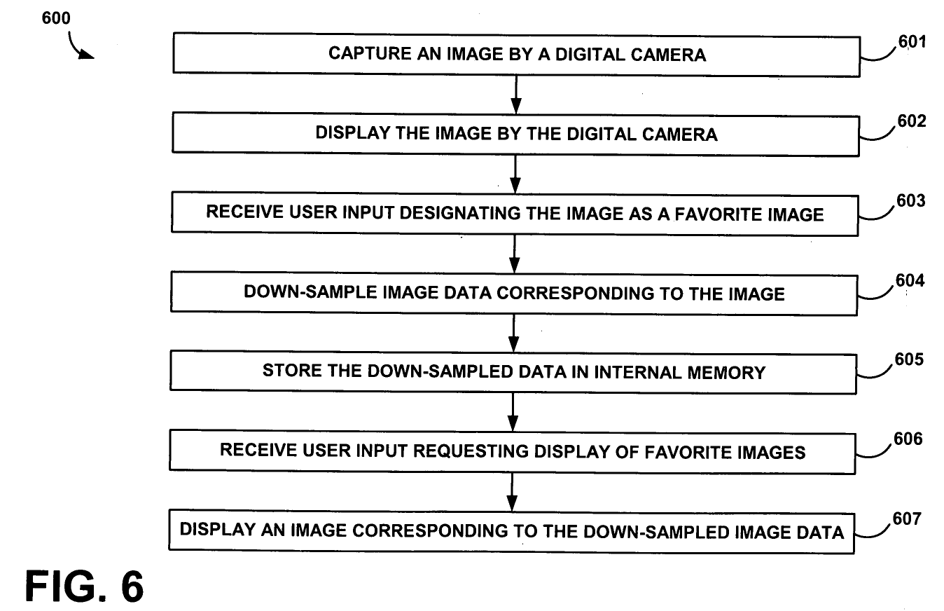

FIG. 6 is a flow chart depicting an example of a method 600 for managing images captured by a digital camera 100. As indicated in step 601, an image is captured by the digital camera 100. For example, the image may be captured by a photo-sensor in the digital camera 100. The image is then displayed by the digital camera 100, as indicated in step 602. In other words, image data corresponding to the captured image may be forwarded to a display component (e.g., liquid crystal display (LCD)) of the digital camera 100, or to an external display device (e.g., a television).

User input designating the image as a favorite image may then be received by the digital camera 100, as indicated in step 603. The user input may either be received via, for example, user-input keys or via a touch-sensitive display. In one embodiment, the user input corresponds to an option displayed on the digital camera's display.

The digital camera 100 down-samples image data corresponding to the displayed image responsive to the user input, as indicated in step 604. The image data may be down-sampled by, for example, selecting pixel data corresponding to one pixel in each of a plurality of pixel clusters within the image. In an alternative embodiment, pixel values for two or more pixels in each of the plurality of pixels clusters may be used to calculate pixel values for a subset of pixels corresponding to the down-sampled image.

The down-sampled data may then be stored by the digital camera 100 in internal memory 108 that is a fixed part of the digital camera 100, as indicated in step 605. Such internal memory 108 preferably comprises non-volatile memory so that image data stored in the internal memory 108 will be preserved even after the digital camera's battery is removed or expires. Note that in another embodiment, the down-sampled data may be stored in a memory device (e.g., a memory card) that is coupled to the digital camera 100.

The digital camera 100 then receives user input requesting display of favorite images, as indicated in step 606. The user input may be provided via a user-input key on the digital camera 100 or via a remote control (e.g., when the camera is being used to output images to an external display device). Responsive to receiving such user input, the digital camera 100 displays an image corresponding to the down-sampled image data, as indicated in step 607. For example, the down-sampled image data may be retrieved from non-volatile memory of the digital camera 100 and forwarded to the camera's display component and/or output to an external display device. Such an image may be displayed immediately after receiving the user input or may be subsequently displayed or as part of a slide-show of favorite images.

Audio clips associated with the original high-resolution image may be optionally saved along with the lower-resolution favorite image and played back when the favorite image is subsequently viewed by a user. Furthermore, down-sampled video clips may also be saved as favorites. However, since video data may occupy too much memory, one or more selected frames of a video clip may alternatively be stored as favorites.

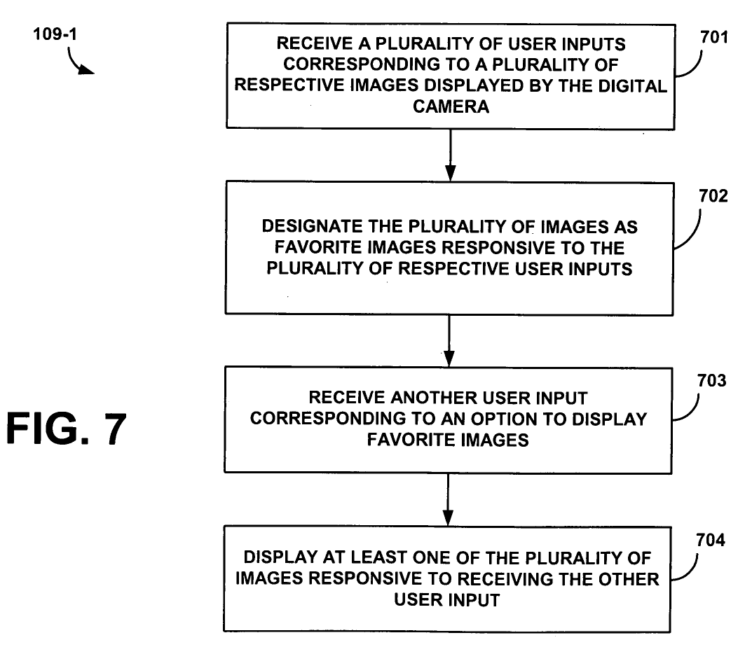

FIG. 7 is a flow chart depicting an example of a method 109-1 for displaying favorite images by the digital camera 100. The method 109-1 may be implemented at least in part by, for example, the GUI application 109 (FIG. 1). As indicated in step 701, a plurality of user inputs corresponding to a plurality of respective images displayed by the digital camera 100 are received. For example, each of the plurality of user inputs may be provided by selecting the add-to-favorites option 302 (FIG. 3). The plurality of images are then designated as favorite images responsive to the plurality of respective user inputs, as indicated in step 702. In one embodiment, each of the plurality of images that is designated as a favorite image may be retrieved from a memory card or from internal memory 108, may be down-sampled, and may be stored in either the memory card or internal memory 108.

Another user input corresponding to an option to display favorite images is received, as indicated in step 703. Such a user input may be provided by, for example, selecting the view favorites option 301 (FIG. 3). Then, as indicated in step 704, at least one of the plurality of images is displayed responsive to receiving the other user input. The favorite image may be displayed via, for example, the display 107 (FIG. 2) of the digital camera 100. Alternatively, the favorite image may be output to an external display device (e.g., a television).

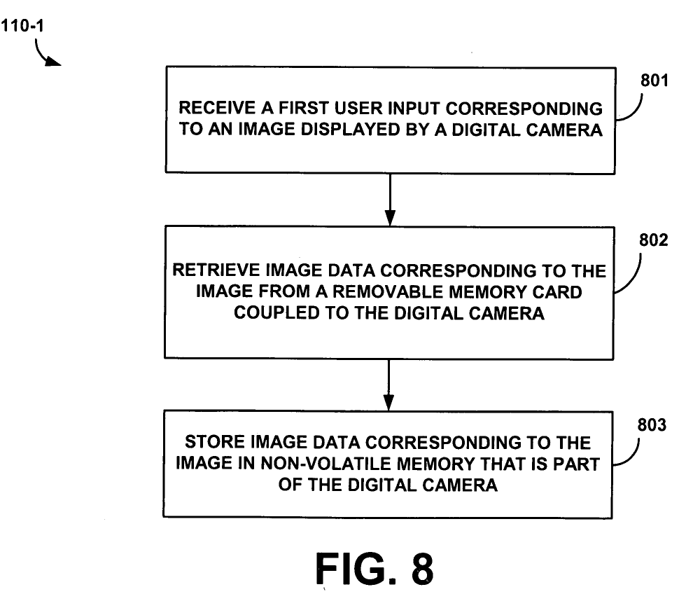

FIG. 8 is a flow chart depicting an example of a method 110-1 for managing images captured by a digital camera 100. The method 110-1 may be implemented at least in part by, for example, the image management application 110 (FIG. 1). As indicated in step 801, a first user input corresponding to an image displayed by a digital camera 100 is received. A user may provide such user input by, for example, selecting the add-to-favorites option 302 (FIG. 3). Responsive to receiving the first user input, image data corresponding to the image is retrieved from a removable memory card coupled to the digital camera 100, and is stored in non-volatile memory that is part of the digital camera 100, as indicated in steps 802 and 803, respectively. In this manner, a user's favorite images may be viewed by the user at a later time, even after the original high-resolution image has been subsequently deleted or over-written.

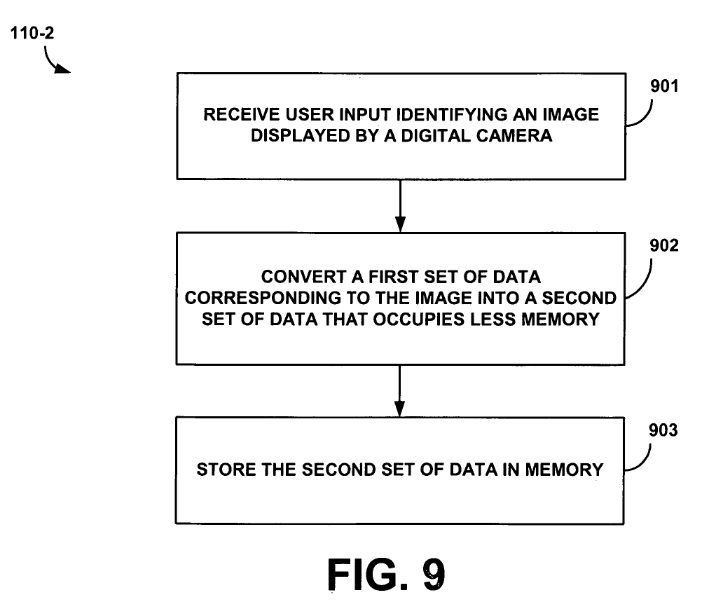

FIG. 9 is a flow chart depicting an example of another method 100-2 for managing images captured by a digital camera 100. The method 100-2 may be implemented at least in part by, for example, the image management application 100 (FIG. 1). The method 110-2 enables a relatively large number of a user's favorite images to be stored in the digital camera 100. As indicated in step 901, user input corresponding to a displayed image is received. A user may provide such user input by, for example, selecting the add-to-favorites option 302 (FIG. 3). A first set of data corresponding to the selected image is converted into a second set of data that occupies less memory, as indicated in step 902. This conversion may be accomplished by down-sampling the first set of data. Alternatively, the conversion may be accomplished by compressing the data, as by using compression algorithms such as those known in the art. The conversion m ay even be performed by using, for example, a combination of down-sampling and compression. The second set of data is then stored in non-volatile memory, as indicated in step 903. The non-volatile memory may be part of the digital camera's internal memory 108 or may be part of a memory card that is coupled to the digital camera 100.

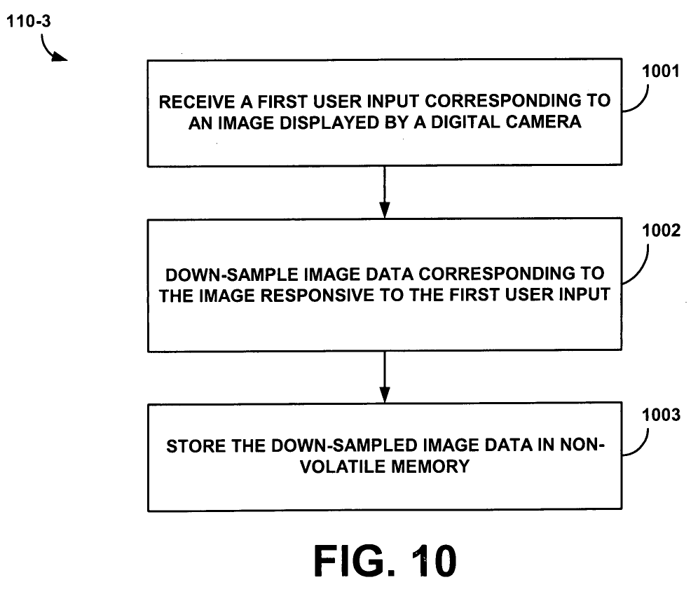

FIG. 10 is a flow chart depicting another example of a method for managing images captured by the digital camera 100 depicted in FIG. 1. As indicated in step 1001, a first user input corresponding to an image displayed by a digital camera 100 is received. Image data corresponding to the image is down-sampled responsive to the first user input, and the down-sampled image data is then stored in non-volatile memory, as indicated in steps 1002 and 1003, respectively.

A simple approach to down-sampling (which may be performed, for example, by the image management application 110 (FIG. 1)) may involve dividing the image into a predetermined number of regions, selecting one or more pixels from each of the regions, and then discarding the non-selected pixels. Other down-sampling techniques may alternatively be used. For example, a plurality of pixel values in the first set of data may be used to calculate each of the pixel values in the second set of data (e.g., by averaging the pixel values).

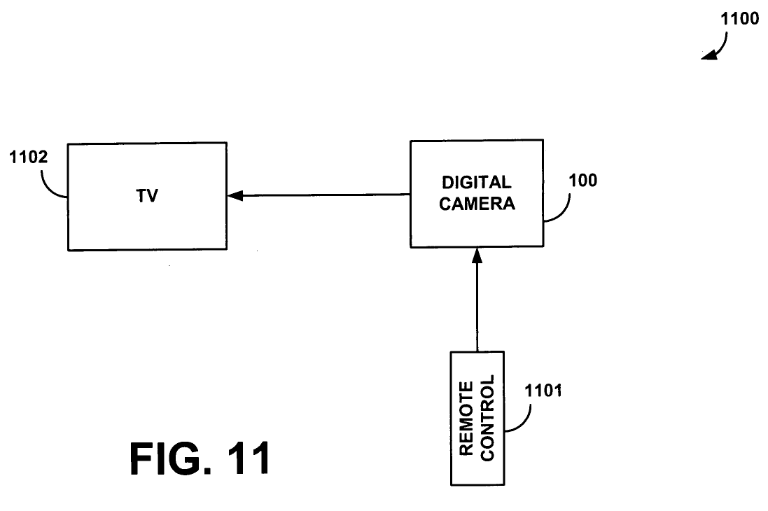

FIG. 11 is a block diagram depicting an example of a favorite images viewing system 1100 that includes a digital camera 100 communicatively coupled to a television 1102. A remote-control 1101 provides user input to the digital camera 100. A user may use the remote-control 1101 to scroll through favorite images that are output by digital camera 100 to the television 1102. The remote-control 1101 may, for example, include input keys similar in form and/or function to the user-input keys 101 (FIG. 2).

As a non-limiting example, a user may use a select button 206 (FIG. 2) located on the remote control 1101 to select a view favorites option 301 (FIG. 3) displayed on the television 1102. Responsive to this user selection, a first favorite image may be output by the digital camera 100 to the television 1102. Another favorite image may then be output to the television 1102 each time the user activates an arrow key 205 (FIG. 2) located on the remote control 1101.

It should be emphasized that the above-described embodiments are mere examples of possible implementations. Therefore, many variations and modifications may be made to the above-described embodiments. All such modifications and variations are intended to be included herein within the scope of the disclosure.

1. A method implemented by a digital camera, comprising the steps of:
receiving a first user input corresponding to an image displayed by a digital camera;
down-sampling image data corresponding to the image responsive to the first user input; and
storing the down-sampled image data in non-volatile memory.

2. The method of claim 1, wherein the non-volatile memory is part of a digital camera.

3. The method of claim 1, wherein the non-volatile memory is part of a memory card that is coupled to the digital camera.

4. The method of claim 1, further comprising outputting the down-sampled image data to a television responsive to a second user input.

5. The method of claim 1, further comprising:
retrieving the image data from a memory card coupled to the digital camera prior to down-sampling the image data.

6. The method of claim 1, further comprising:
retrieving the image data from the non-volatile memory prior to down-sampling the image data, wherein the non-volatile memory is part of the digital camera.

7. The method of claim 1, further comprising:
capturing the image prior to receiving the first use input;
displaying the image prior to receiving the first use input;
receiving a second user input corresponding to an option to view favorite images; and
displaying an image that is constructed using the down-sampled image data.

8. A method implemented by a digital camera, comprising the steps of:
receiving a first user input corresponding to an image displayed by a digital camera; and
responsive to receiving the first user input:
retrieving image data corresponding to the image from a removable memory card coupled to the digital camera; and
storing image data corresponding to the image in non-volatile memory that is part of the digital camera.

9. The method of claim 8, further comprising:
capturing the image prior to receiving the first use input; and
displaying the image prior to receiving the first use input.

10. The method of claim 8, further comprising outputting image data corresponding to the image to a television.

11. The method of claim 8, further comprising down-sampling the retrieved image data prior to the step of storing.

12. The method of claim 8, further comprising:
receiving a second user input corresponding to an option to view favorite images; and
displaying the image responsive to the second user input.

13. A method implemented by a digital camera, comprising the steps of:
receiving a plurality of user inputs corresponding to a plurality of respective images displayed by the digital camera;
designating the plurality of images as favorite images responsive to the plurality of respective user inputs;
receiving another user input corresponding to an option to display favorite images; and
displaying at least one of the plurality of images responsive to receiving the other user input.

14. The method of claim 13, further comprising outputting at least one of the plurality of images to a television.

15. The method of claim 13, further comprising, responsive to the plurality of user inputs:
down-sampling the plurality of images; and
storing the down-sampled images in non-volatile memory in the digital camera.

16. The method of claim 13, further comprising:
capturing each of the plurality of images;
displaying each of the plurality of images.

17. A digital camera comprising:
non-volatile memory; and
at least one processor that is programmed to:
down-sample image data corresponding to an image displayed by the digital camera responsive to the digital camera receiving a user input; and
provide the down-sampled image data to the non-volatile memory.

18. The digital camera of claim 17, wherein the image data is retrieved from the non-volatile memory prior to being down-sampled.

19. The digital camera of claim 17, wherein the at least one processor is further programmed to enable the down-sampled image data to be provided to a television.

20. The digital camera of claim 17, wherein the image data is retrieved from a memory card coupled to the digital camera prior to the image data being down-sampled.

21. The digital camera of claim 17, further comprising:
a photo-sensor configured to sense light corresponding to the image;
a display configured to display the image; and
a user-input interface configured to receive the user input.

22. A digital camera comprising:
a display; and
at least one processor that is programmed to:
designate a plurality of images as favorite images responsive to the digital camera receiving a plurality of respective user inputs; and
provide image data corresponding to at least one of the plurality of images to the display responsive to the digital camera receiving another user input corresponding to an option to display favorite images.

23. The digital camera of claim 22, wherein the at least one processor is further programmed to enable image data corresponding to at least one of the plurality of images to be provided to a television.

24. The digital camera of claim 22, wherein the at least one processor is further programmed to down-sample data corresponding to each of the plurality of images responsive to each of the plurality of respective user inputs.

25. The digital camera of claim 22, further comprising non-volatile memory configured to store the down-sampled data.

26. The digital camera of claim 22, wherein the at least one processor is further programmed to provide the down-sampled data to the non-volatile memory.

27. The digital camera of claim 22, further comprising:
a photo-sensor configured to sense light corresponding to the image;
a user-input interface configured to receive the user input.

28. A digital camera comprising:
means for receiving a plurality of user inputs corresponding to a plurality of respective images displayed by the digital camera;
means for designating the plurality of images as favorite images responsive to the plurality of respective user inputs;
means for displaying at least one of the plurality of images responsive to receiving another other user input corresponding to an option to display favorite images.

29. The digital camera of claim 28, further comprising a means for outputting at least one of the plurality of images to a television.

30. The digital camera of claim 28, further comprising:
means for down-sampling the plurality of images; and
means for storing the down-sampled images.

31. The digital camera of claim 28, further comprising:
means for capturing each of the plurality of images; and
means displaying each of the plurality of images.

32. A method implemented by a digital camera, comprising the steps of:
receiving a first user input corresponding to an image displayed by a digital camera;
converting a first set of data corresponding to the image to a second set of data responsive to the first user input, wherein the second set of data is smaller than the first set of data; and
storing the second set of data in non-volatile memory.

33. The method of claim 32, wherein the non-volatile memory is part of a digital camera.

34. The method of claim 32, wherein the non-volatile memory is part of a memory card that is coupled to the digital camera.

35. The method of claim 32, further comprising outputting the second set of data to a television responsive to a second user input.

36. A computer readable medium having stored thereon computer-readable instructions configured to enable:
receiving a first user input corresponding to an image displayed by a digital camera;
converting a first set of data corresponding to the image to a second set of data responsive to the first user input, wherein the second set of data is smaller than the first set of data; and
storing the second set of data in non-volatile memory.
